(19) United States
(12) Patent Application Publication
(10) Pub. No.: US 2012/0169107 A1
(43) Pub. Date: Jul. 5, 2012

(54) SEAT FRAME AND METHOD OF FORMING USING A LASER WARMED ADJESIVE

(76) Inventors: Daniel James Sakkinen, Highland, MI (US); Nicholas Leonard Petouhoff, South Lyon, MI (US); Anthony Kestian, Highland, MI (US); Eric Michalak, Northville, MI (US)

(21) Appl. No.: 13/265,514

(22) PCT Filed: Apr. 21, 2010
(86) PCT No.: PCT/US10/31918

§ 371 Date: Dec. 30, 2011

Related U.S. Application Data
(60) Provisional application No. 61/171,117, filed on Apr. 21, 2009.

(51) Int. Cl. B60N 2/68; B29C 65/54

(52) U.S. Cl. 297/452.18; 156/272.8

(57) ABSTRACT

A seat frame for use in a vehicle having a first seat frame member and a second seat frame member is provided. At least one of the first seat frame member and the second seat frame member has an adhesive positioned thereon. The adhesive is curable by heat generated by a diffused laser beam from a laser welder. A portion of the first seat frame member and a portion of the second seat frame member are positioned adjacent one another, such that a joint is formed and the adhesive is positioned between the portion of the first seat frame member and the portion of the second seat frame member. The seat frame is configured such that the diffused laser beam can be directed at the joint to heat the adhesive and thereby form a bond between the first seat frame member and the second seat frame member.

### CROSS-REFERENCE TO RELATED APPLICATIONS

This application claims the benefit of and priority to U.S. Provisional Patent Application No. 61/171,117, filed Apr. 21, 2009, which is incorporated herein by reference.

### BACKGROUND

The present disclosure relates generally to the field of seat frames. More particularly, the present invention relates to the design and manufacturing of a seat frame having multiple support members that are coupled together using a welding process and a laser warmed adhesive.

A variety of seat frame systems, designs, configurations, and methods of manufacturing are used in the automotive industry. Manufacturers of seat frames continually strive to provide improved seat frame designs that can be manufactured in a more cost-efficient manner. Several known welding processes are used to couple or fix together support members of a seat frame. Known welding processes include, for example, resistance spot welding and gas metal arc welding (e.g., Metal Insert Gas (MIG), Tungsten Inert Gas (TIG)) processes. Demands for improved production quality, productivity, and flexibility have caused manufacturers to seek alternatives to the above-mentioned welding processes. Adhesive bonding has been viewed as one possible alternative especially for joining unweldable combinations of materials such as metals to plastics or ferrous to non-ferrous metals. Adhesive bonding is well known for its flexibility in joining a variety of materials. The adhesives that are capable of handling the structural load and durability requirements of automotive seating require a combination of high strength and toughness from the moment that the components are brought together and throughout the complete seat assembly and use in the vehicle.

Known seat frames are often designed to be welded by one particular welding process, and generally cannot be joined by an alternative welding process because of differences in the tooling requirements and/or the limitations of the process. For example, if a seat frame is designed to be welded specifically by a resistance spot welding process, it is unlikely that the same design can be welded by an alternative welding process without significant redesign. In addition, known seat frames often have weld spots along varying planes, sides, surfaces, orientations, etc., which require the seat frame system to be turned, flipped, rotated, or otherwise repositioned during a welding process in order to obtain access to each weld spot.

Thus, there is a need for a method of manufacturing a seat frame system wherein the seat frame members may be coupled together using an adhesive and the existing laser welding system provides the heat to cure the adhesives.

### SUMMARY

A seat frame for use in a vehicle having a first seat frame member and a second seat frame member is provided. At least one of the first seat frame member and the second seat frame member has an adhesive positioned thereon. The adhesive is curable by heat generated by a diffuse laser beam from a laser welder. A portion of the first seat frame member and a portion of the second seat frame member are positioned adjacent one another, such that a joint is formed and the adhesive is positioned between the portion of the first seat frame member and the portion of the second seat frame member. The seat frame is configured such that the diffuse laser beam can be directed at the joint to heat the adhesive and thereby form a bond between the first seat frame member and the second seat frame member.

A method of forming a seat frame for use in a vehicle is also provided. The method includes providing a first seat frame member and a second seat frame member. The method further includes positioning an adhesive on at least one of the first seat frame member and the second seat frame member. The method further includes positioning a portion of the first seat frame member and a portion of the second seat frame member adjacent one another, such that a joint is formed and the adhesive is positioned between the portion of the first seat frame member and the portion of the second seat frame member. The method also includes directing a diffuse laser beam from a laser welder at the joint to heat the adhesive and thereby form a bond between the first seat frame member and the second seat frame member.

Advantageously, a seat frame and a method of manufacturing a seat frame using a laser warmed adhesive is provided that may utilize various types of welding processes, such as a remote beam laser welding process, a resistance spot welding process, a gas metal arc welding process to both weld and cure an adhesive to form a joint. Another advantage of the present disclosure is that the weld spots are accessible without having to manipulate the orientation of the seat frame being welded together. Still another advantage of the present disclosure is that the laser is selectively adjusted to cure the adhesive by indirect heat transfer, and well as in another welding operation. A further advantage of the present disclosure is that utilizing one laser for multiple purposes increases the efficiency of manufacturing the seat assembly and is more cost effective.

These and other features and advantage of the present disclosure will be readily appreciated as the same becomes better understood after reading the subsequent description taken in conjunction with the accompanying drawings.

### BRIEF DESCRIPTION OF THE DRAWINGS

FIG. 1 is a perspective view of a vehicle including a vehicle seat, according to an exemplary embodiment.

FIG. 2A is a perspective view of a vehicle seat of the vehicle of FIG. 1, according to an exemplary embodiment.

FIG. 2B is a perspective view of a vehicle seat frame assembly, according to an exemplary embodiment.

FIG. 3 is a perspective view of a seat frame system, according to an exemplary embodiment.

FIG. 4 is a partial perspective view of an upper corner portion of the seat frame system of FIG. 3, according to an exemplary embodiment.

FIG. 5 is a front plan view of the seat frame system of FIG. 3 showing lines of sight between a work head and a plurality of weld spots, according to an exemplary embodiment.

FIG. 6 is a perspective view of the seat frame system and lines of sight of FIG. 5, according to an exemplary embodiment.

FIG. 7 is a flow chart diagram illustrating a method of forming a seat frame using a laser warmed adhesive, according to an exemplary embodiment.

FIG. 8 is an exploded view of the seat structure showing the location of the overlap joints in which the adhesive is used to join the seat components together, according to an exemplary embodiment.

FIG. 9 is a diagram of a joint between two seat components and uncured adhesive there between, according to an exemplary embodiment.

FIG. 10 is a diagram of the joint shown in FIG. 9 and a diffuse laser beam being directed at a seat component to warm the sheet material of the seat component and thereby heat the adhesive through conduction, according to an exemplary embodiment.

FIG. 11 is a diagram of the assembled seat frame as it is laser heated to activate curing of the adhesive joints, according to an exemplary embodiment.

### DETAILED DESCRIPTION

Referring generally to the FIGURES and in particular to FIG. 1, a vehicle 10 is illustrated, which in this example is an automotive vehicle. The vehicle 10 includes seat 12 provided for an occupant of the vehicle 10. While the vehicle 10 shown is a 4-door passenger car, it should be understood that the seat 12 may be used in another type of vehicle, such as a mini-van, sport utility, cross-over or any other type of vehicle. While the seat of this example is illustrated with respect to a vehicle, the type and usage of the seat is non-limiting.

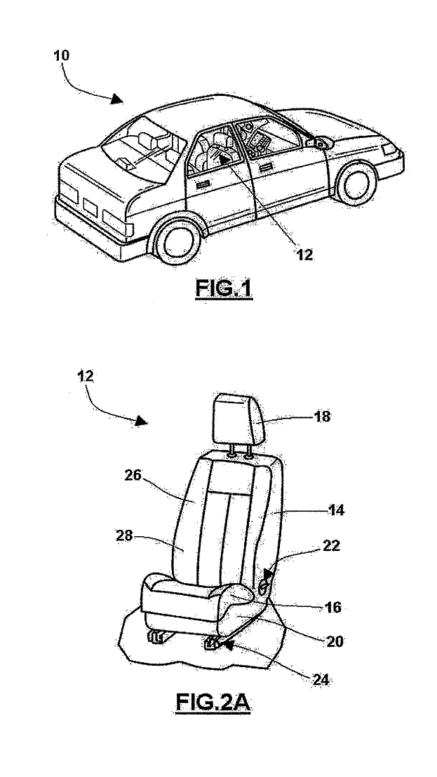

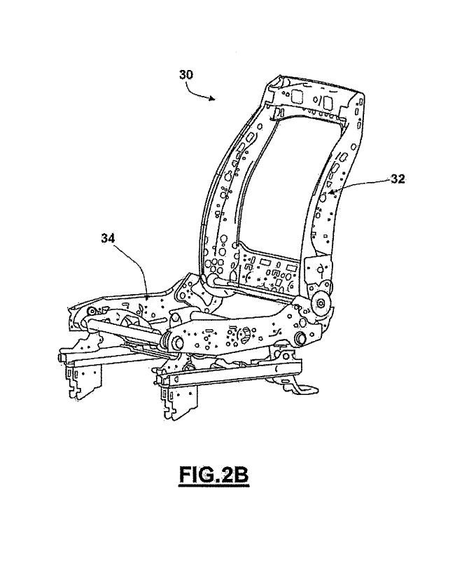

Referring now to FIG. 2A, a seat assembly 12 is shown having a seat back 14 attached to a seat cushion (base) 16 is illustrated. In this example, the seat back 14 is pivotally attached to the seat cushion 16 via a recliner mechanism 18 which enables the seat back to be selectively pivoted in the fore and aft directions The seat 12 of this example also includes a head restraint 18 and a seat base portion 20 for supporting the seat cushion 16. The head restraint 18 extends upward from the seat back 14 and is operatively restrains the head of an occupant due to an unintended force applied to the vehicle. The seat cushion 16 and/or base portion 20 may be selectively positioned relative to the vehicle interior via a track assembly 24. The seat assembly 12 can also include additional components, such as a foam pad/cushions 26, a trim cover 28, or the like. The seat assembly 12 illustrated is a one-occupant seat, but the seat structure of the present disclosure may be incorporated into any type of seat assembly such as a bench seat or the like, which may utilize any type of seat functionality, for use within any type of vehicle. The seat structure 12 can also include a seat frame assembly 30, as shown in FIG. 2B.

The seat frame assembly 30 includes a generally vertically oriented seat back frame portion 32 and a generally horizontally oriented seat base frame portion 34. The seat frame 30 includes a plurality of members joined together to form the structure. The seat frame members may be formed from various materials, such as steel or another metal, plastic or composite or the like. The members of seat frame 30 joined together, such as by welding bonding, fastening or the like. In this example, the seat frame members may be joined using more than one process. For example, the members of seat frame assembly 30 may be welded using one or more of a (1) a remote beam laser welding process; (2) a resistance spot welding process; and (3) a gas metal arc welding process. By providing flexibility in the joining process that can be used to couple the members together, the seat frame assembly 30 can be manufactured in a variety of manufacturing environments, including manufacturing environments where certain welding processes may be economically impracticable or otherwise unavailable. An example of a seat back frame and method of forming a seat frame using a process, such as a laser welding process, is disclosed in commonly assigned PCT Application PCT/US2005/041499 which is incorporated in its entirety herein by reference.

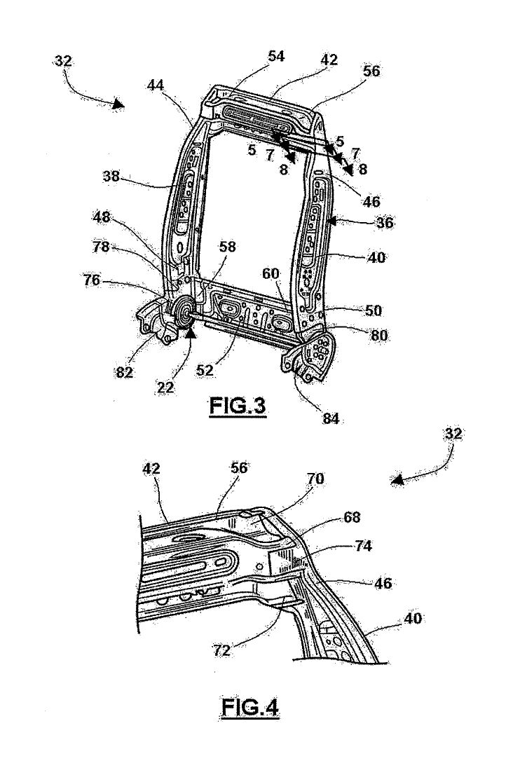

FIG. 3 is a perspective view of seat back frame 32 which generally includes an outer peripheral frame 36. According to an exemplary embodiment, seat back frame 32 includes a pair of spaced apart side support members 38, 40 and at least one cross support member, shown as an upper or first cross support member 42 located toward a second end 44, 46 of side support members 38, 40. In this example, side support members 38, 40 each have a length greater than the length of first cross support member 42, to provide the seat frame 32 with a substantially rectangular configuration. In another example, side support members 38, 40 may have a length substantially equal to the length of first cross support member 42, or the side support members 38, 40 may have a length less than the length of first cross support member 42, and other configurations are contemplated.

Side support members 38, 40 extend longitudinally (e.g., vertically, etc.) from first ends 48, 50 to second ends 44, 46 respectively, while first cross support member 42 extends in a direction substantially transverse (e.g., horizontal, lateral, perpendicular, etc.) to side support members 38, 40. The seat frame 30 is further shown as including a lower or second cross support member 52 extending in a direction transverse to side support members 38, 40 and located toward first ends 48, 50 of side support members 38, 40, respectively.

According to various other exemplary embodiments, seat back frame 30 may include any number of support members extending in a number of directions such as horizontally, vertically, diagonally, etc. In one embodiment (not shown), frame 30 may include a pair of spaced apart side members and a single cross support member. In this manner, frame 30 can be configured as a U-shaped frame with the side member extending transverse to the side support members at one end. As can be appreciated, frame 30 may have a variety of known or otherwise appropriate configurations. It should further be noted that the support members of frame 38, 40 can have any suitable number and shapes of ridges and apertures for improving the rigidity of frame 30 and/or reducing the weight.

The first cross support member 42 includes a first end 54 secured substantially near and/or at second end 44 of first side support member 38, and an opposite second end 56 secured substantially near and/or at second end 46 of second side support member 40. Second cross support member 52 includes a first end 58 secured substantially near first end 48 of first side support member 38, and an opposite second end 60 secured substantially near first end 50 of side support member 40. As can be appreciated, first cross support member 42 and second cross support member 52 may be located anywhere along the length of the side support members 38, 40.

The side support members 38, 40 are secured to first cross support member 42 and second cross support member 52 at a an interface also referred to as a weld or bond spot, as shown at 62 using a joining method to be described. As can be appreciated, the seat back frame 32 may have any number of interface spots 62, such as, a weld spot, bond spot, adhesive spot, or the like. The number and/or the location of interface spots 62 may vary depending on factors such as the particular welding and/or bonding process used to join the components, the materials being welded, the application in which the seat frame 30 will be used, or the like.

The interface spots 62 represent areas on frame 32 where side support members 38, 40, first cross support member 42, and second cross support member 52 are sufficiently manipulated during the selected joining process to form an integrated frame assembly. According to an exemplary embodiment, at each interface spot 62, one of side support members 38, 40 and first (upper) cross member 42 or second cross support member 52 is partially disposed over the other of side support members 38, 40 and upper cross member 42 or second cross support member 52.

The seat frame assembly 30 may also include other features, such as, a recliner mechanism 22 configured to provide selective pivotal movement between the seat back 14 and a seat base. Attachment members 78, 80 may be used to couple recliner mechanism 22 to lower first ends 48, 50 of side support members 38, 40, respectively. Attachment members 82, 84 may be used to couple recliner mechanism 22 to the seat base frame 34 (not shown). For example, attachment members 78, 80 may be integrally formed with side support members 38, 40, or may be provided as separate plates that are coupled to side support members 38, 40.

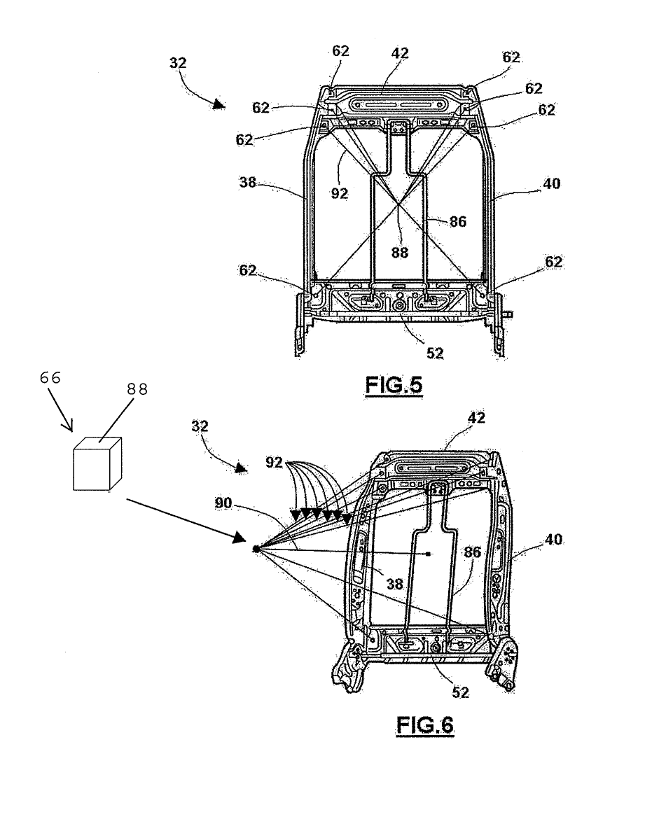

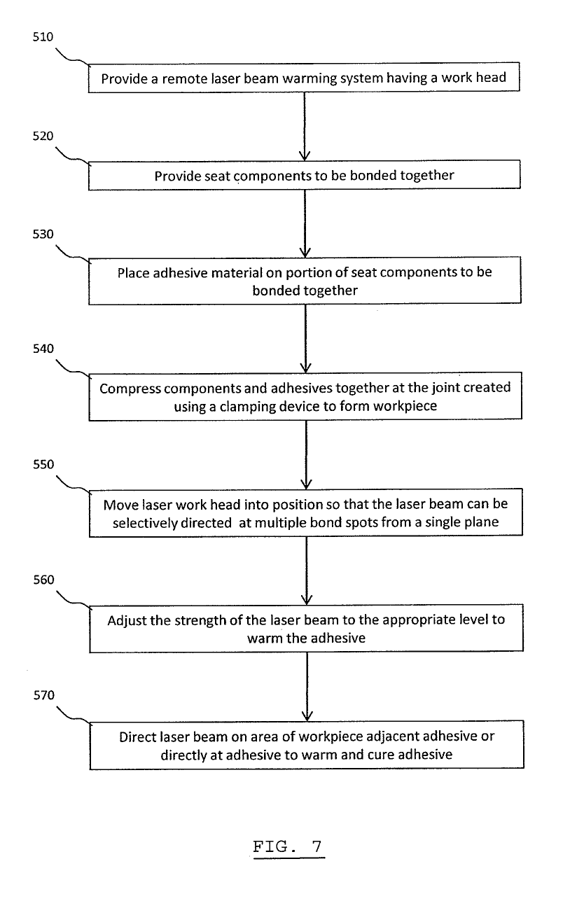

Frame 32 may be covered by a padded, foam or cushioned layer 26, which may further be covered by a trim cover material 28 such as leather, vinyl, and any other known or appropriate material. As shown in FIGS. 5 and 6, a wire 86 extends longitudinally between upper support member 42 and lower support member 52 to support seat springs, a lumber adjustment device, and/or padding (not shown). In another example, the wire 86 may extend transversely between side support members 38, 40.

Referring now to FIG. 4 is a corner of seat frame system 30 illustrating a plurality of interface spots 62 that have been individually referenced as weld or bond spots, 68, 70, and 72, respectively, is shown. Although, the configuration of weld or bond spot 68 is described in detail herein, other interface spots 62 of frame, including those individually referenced as weld or bond spots 70 and 72, may have a similar configuration for enabling a lesser clamping force to provide and maintain the desired size of gap 64.

For example, the weld or bond spot 68 is an interface between second end 46 of side support member 40 and second end 56 of the first cross support member 42. The side support member 40 includes a tab portion 74, configured to be welded or bonded to second end 56 of first cross support member 42. For example, the portion or region of second end 56 interfaced with tab 74 is a relatively rigid portion. The rigidity of such portion may be similar to the rigidity of a conventional seat frame member. In such a configuration, tab 74 is less rigid (e.g., conformable, ductile, bendable, flexible, compliable, etc.) than the relatively rigid portion of first cross support member 42 to which tab 74 is to be welded or bonded. Prior to a welding or bonding process, a force is applied near and/or at tab 74 by a clamping device to draw tab 74 and second end 56 together to achieve and maintain the desired size of gap 64. For such a configuration, the clamping device displaces tab 74 toward second end 56. The welded or bonded combination of tab 74 and second end 56 provides a weld or bond structure suitable for use in a seating application.

Referring now to FIGS. 5-6, a seat back frame is formed using a laser welder or remote laser beam welding system is shown. In this example the laser weld device is a remote beam laser 66 having a work head 88 that directs a laser beam. The remote beam laser system 66 includes work head 88 operatively coupled to a laser generating source (not shown). The laser generating source is a CO₂ laser having a power level of approximately 2 kilowatts (kW) or greater. According to a particular exemplary embodiment, a laser having a power level is in the range of approximately 3 kW to 6 kW may be utilized. Work head 88 may include a mirroring device (not shown) configured to selectively and effectively direct the laser beam to each bond spot 62 on the frame. The laser can also be adjusted to use in the methodology of warming an adhesive as described in detail below.

The work head 88 may selectively direct the laser beam onto the work piece without substantially moving the work head 88. A standoff distance as shown at 90 is provided between the work head 88 and frame 32. The standoff distance 90 may vary depending on a number of factors such as the power of the laser, the type of material being warmed, the size and design of frame, the constraints of the manufacturing environment, and the like. For example, a standoff distance 92 of approximately one meter may be utilized, although the standoff distance 92 may differ based on the factors provided above.

The seat frame system 30 may be oriented so that the frame 32 is capable of being laser warmed from a single plane as shown in FIG. 5 without requiring frame 32 and/or work head 88 (to be substantially repositioned during the laser warming process. To provide such a configuration, each bond spot 62 is accessible by the laser while maintaining work head 88 and frame 32 in a substantially fixed position. As shown in FIGS. 5 and 6, the “line of sight” shown at 92 (i.e., a line extending between work head and bond spots that represents the laser path to each bond spot from work head) is unobstructed for each bond spot 62. An obstructed line of sight may prevent the laser from reaching bond spots. Common obstructions that may interfere with the line of sight include, but are not limited to, portions of the support members, clamping structures, fixtures, or the like.

Referring FIGS. 7-11 and particularly to FIG. 7, a method of manufacturing the seat frame assembly using a joining process is described. For example, side support members 38, 40, first cross support member 42, and second cross support member 52 of frame 32 are designed to be coupled together by various joining processes, such a remote beam laser welding process. In another example, the, seat frame system 32 may be welded together using more than one process, or a combination of processes. According to one exemplary embodiment, the seat frame members are joined together using a thermally activated adhesive that is activated by a laser welder, such as, a remote laser beam system, as described below.

The methodology begins at block 510 and includes the step of providing a laser welder 66 having a work head 88 that can be used for multiple types of welding processes, such as, conventional laser welding to create weld spots, or the like. The same laser welder 66 can be adjusted so that it can be used to heat and cure a thermally activated adhesive.

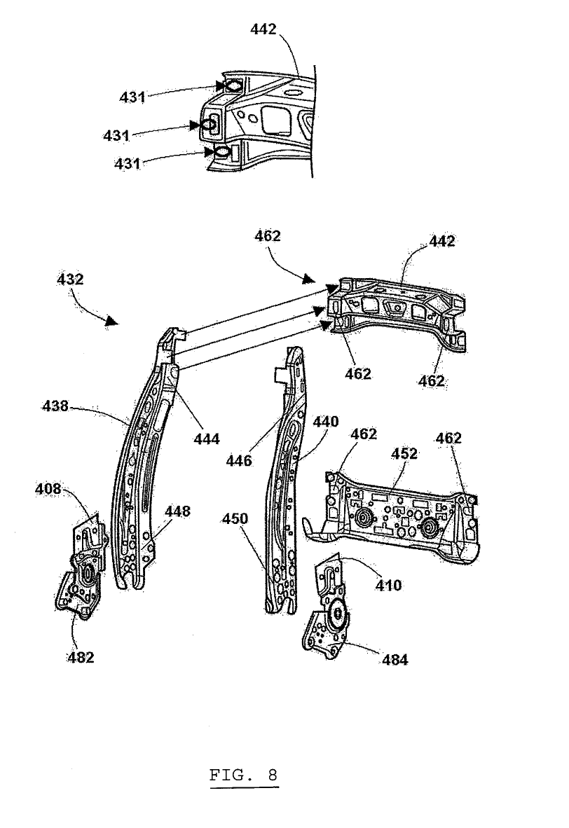

The methodology advances to block 520 and includes the step of providing a first seat frame member adjacent a second seat frame member. For example, a first side frame member can be positioned next to an upper cross frame member to create a joint and an interface spot, such as, a weld spot, or bond spot, adhesive spot, or the like, as shown in FIG. 8.

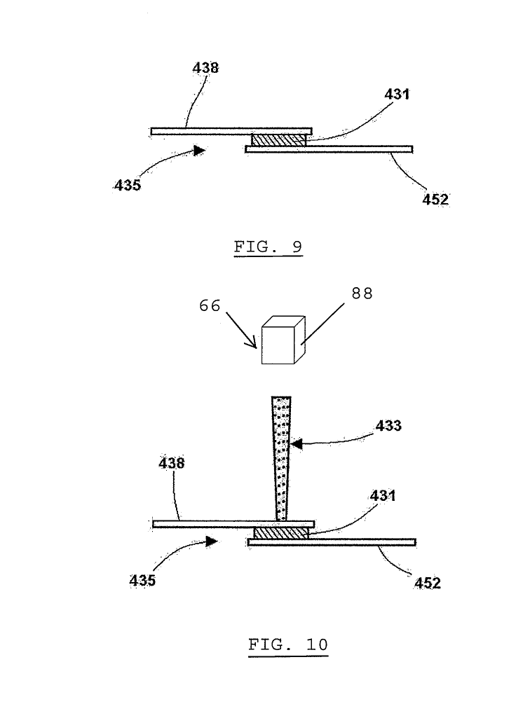

The methodology advances to block 530 and includes the step of positioning an adhesive between the first seat frame member and the second seat frame member at the interface spot. For example, an adhesive may be placed in the gap between the seat frame members, as shown in FIG. 9. Various types of adhesive are contemplated, such as acrylic adhesives, or the like.

The methodology advances to block 540 and includes the step of compressing the first seat frame member and the second seat frame member together. A clamping device can be used to provide a clamping force around each bond spot 62 to compress the seat frame members together.

The methodology advances to block 550 and includes the step of positioning the laser welder 66 or the work head 88 so that a laser beam can be selectively directed at one or more interface spots.

The methodology advances to block 560 and includes the step of adjusting the laser beam intensity to the appropriate level to heat the adhesive. By adjusting the intensity, focus, strength, or level of the laser beam output, the laser beam can be diffused and can be used to heat the adhesive without damaging the seat frame members. For example, the intensity of the laser beam may be selectively determinable in order to create a predetermined warming pattern at each bond spot 62 in order to control the melting of the adhesive.

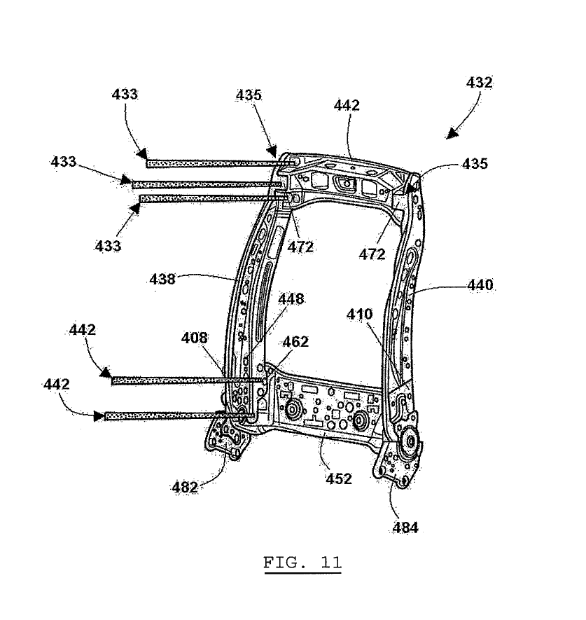

The methodology advances to block 570 and includes the step of directing the laser beam at the interface spot to heat and cure the adhesive, as shown in FIG. 10. The laser beam can be used to indirectly heat the adhesive by focusing the laser beam in an area adjacent the interface spot and adhesive, such as, on the seat frame member. The heat is then transferred from the adjacent region on the seat frame member to the adhesive thereby indirectly heating the adhesive and initiating the curing process. The laser beam can also be directly focused on the adhesive to directly heat the adhesive and initiate the curing process. For example, the laser beam is selectively directed from the work head 88 to each bond spot 62 in order to heat the bond spot. While the order in which each bond spot 62 is heated may vary, according to an exemplary embodiment, the laser beam is directed to each bond spot 62 in a relatively continuous movement (e.g., in a clockwise or a counterclockwise fashion, in a substantially linear fashion, etc.). At each interface spot 62, the laser beam effectively warms the respective support member that it is in contact with and the heat transfer from the support member to the adhesive activates the curing of the adhesive to provide a secure joint, as shown in FIG. 11. The heated adhesive is cured, and as the adhesive cools, a bond or joint is formed between the components to form an integral seat frame.

The methodology advances to block 580 and includes the step of readjusting the laser beam. Here, the laser beam can be readjusted, such as, by increasing the laser beam intensity, strength, or the like, to perform different types of laser welding processes, such as, creating conventional weld spots, or the like.

Referring to FIG. 8, a diagram of seat frame system 430 having components coupled together using an adhesive 431 cured by heat generated by a laser, using the described methodology is illustrated. The adhesive 431 may be used to bond structural components of a seat frame 432 (e.g., side members 438, 440, upper cross member 442, lower cross member 452, recliner brackets 408, 410, recliner members 482, 484, etc.) together. Adhesive bonding may be desirable when joining dissimilar materials together or similar materials that are not sufficiently weldable by conventional methods, such as, GMAW, spot welding, laser welding, TIG, etc. or the like. In this example, the adhesive 431 is a two-part epoxy adhesive which requires an elevated temperature curing operation in order to develop sufficient strength for the joint to survive normal handling. For example, an automotive structural adhesive offered by 3M, such as, the two-part epoxy adhesive 7036 requires a low temperature activation at or below 200° F. (93° C.). Therefore, the laser could be configured to heat the adhesive 431 to approximately 200° F. (93° C.) in order to activate the curing process. Once the adhesive 431 has been heated it will chemically react to form a sufficiently strong bond. To form the bond it may be necessary to heat the adhesive 431 in spot in the intended weld and then initiate the curing process. Conventionally, heat is provided by induction heating or convection heating. According to the exemplary embodiment of the present disclosure, laser welding equipment 466 is used to provide heat to the adhesive 431 by making the laser beam more diffuse than that which is required for laser welding to form the bond. Advantageously, if there is existing laser equipment used for laser welding to couple the components, then the existing laser welding equipment may be converted and used with the new adhesive warming process without negatively impacting the production process while obtaining the benefits of adhesive welding. Further, such an added adhesive product 431 and process to an existing laser welding process (i.e., manufacturing line) provides significant additional manufacturing flexibility at a relatively very low added capital expense.

As shown in FIG. 8, the seat structure 432 includes a first and second side members 438, 440, a first (upper) cross member 442, a second (lower) cross member 452, a first and second recliner bracket 408, 410, and a first and second recliner member 482, 484, that are positioned together in the appropriate orientation to form a frame. An adhesives 431, such as, the 3M two-part epoxy or the like may be placed on one or both ends of the first seat component and the second seat component, such that, when the laser beam is directed to the joint, the adhesive 431 begins to cure and forms a strong bond between the seat components (e.g., first side member 438 and first (upper) cross member 442, etc.) and thereby couples the seat components together to form the seat structure 432. Although three adhesive pads 431 are shown in FIG. 8, it should be understood that any number of adhesive pads 431 may be used to bond the components together. Moreover, the adhesives 431 may be placed at any suitable location on the components. For example, the adhesives 431 may be placed on any number of the intended weld spots 462 described throughout this disclosure which provide a clear line of sight 492 for the laser beam to heat the joint 435 and initiate the curing process.

As shown in FIG. 9, the adhesive layer 431 is located and preferably contained between the components of the vehicle seat assembly, such as between the first side member 438 and first (upper) cross member 442. The adhesive 431 may be relatively lower strength as applied but gains significant and sufficient bonding strength once heated using the laser warming source.

As shown in FIG. 10, the laser beam 433 is directed at the intended adhesive joint 435. More specifically, the laser beam is directed in the adjacent area of the joint in order to locally and sufficiently heat the adhesive material 431 and thus activate the curing process within the adhesive 431. In one embodiment, the laser is directed at a portion of the frame, such as the side member, and the heat is transferred from the frame to the adhesive. It should be appreciated that the level of heating is controlled so that the heating does not significantly affect the structural characteristics of the vehicle seat components. The laser heating is sufficient to initiate the curing process of the adhesive 431 such that the coupling strength of the adhesive sufficiently increases and the vehicle seat components can be handled as a structural component. Alternatively, the laser can be aimed directly at the adhesive to directly heat the adhesive and initiate the curing process.

Referring now to FIG. 11, a diagram of the assembled seat frame 432 as it is laser heated to activate curing of the adhesive joints 435 is shown, according to an exemplary embodiment. The diffuse laser beam 433 warms the multiple bond joints 435 (or interface spots) in order to activate the curing of the adhesive 431. The same laser system that is used to weld components together may be de-powered to provide heating without melting the components and adhesive 431. The same fixtures (e.g., clamping devices, etc.) used to locate and hold down components for laser welding may be used for the laser curing process.

As can be appreciated, in certain applications, the use of one joining process may be more appropriate and/or more favorable than the use of another. In addition, a manufacturing environment may already be established with one type of welding system, and changing over to another welding system may not be practical. Example of welding processes include: remote beam laser welding; resistance spot welding; gas metal arc welding (GMAW); and/or laser warmed and cured adhesive bonding. The welding/bonding processes may be used individually or may be used in combination with one or more of the other welding/bonding processes to join members in forming the frame 32. In another example, mechanical fasteners, such as, bolts, rivets, pins, screws, or the like, may be used in combination with the selected welding/bonding process.

The present disclosure has been described in an illustrative manner. It is to be understood that the terminology, which has been used, is intended to be in the nature of word of description rather than of limitation. Many modifications and variations of the present disclosure are possible in light of the above teachings. Therefore, within the scope of the claims, the present disclosure may be practiced other than as specifically described.

What is claimed is:

1. A seat frame for use in a vehicle, the seat comprising:
a first seat frame member;
a second seat frame member;
an adhesive positioned between the first seat member and second seat member at an interface spot, wherein the adhesive is cured by focusing a laser beam from a laser welder at the interface spot to heat at least one of the first seat frame member and the second seat frame member such that heat is transferred to the adhesive.

2. The seat frame of claim 1, wherein the seat frame includes a first interface spot formed by a laser weld and a second interface spot formed by an adhesive bond using the same laser welder.

3. The seat frame of claim 1, wherein the laser welder output is adjustable to vary the cure rate of the adhesive.

4. The seat frame of claim 1, wherein the laser beam heats the first seat frame member to indirectly heat the adhesive.

5. The seat frame of claim 1, wherein the laser beam heats the second seat frame member to indirectly heat the adhesive.

6. A method of forming a seat frame, the method comprising the steps of:
providing a first seat frame member;
locating a second seat frame member with respect to the first seat frame member;
positioning an adhesive between the first seat frame member and the second seat frame member at an interface spot; and
focusing a laser beam from a laser welder at the interface spot to heat and cure the adhesive and form a joint between the first seat frame member and the second seat frame member.

7. The method of claim 6, further comprising the step of focusing the laser beam on an area adjacent the adhesive to indirectly heat and cure the adhesive.

8. The method of claim 7, further comprising the step of focusing the laser beam on the adhesive to directly heat and cure the adhesive.

9. The method of claim 8, further comprising the step of selectively adjusting the output of the laser welder to control the cure rate of the adhesive.

10. The method of claim 9, further comprising the step of using the laser welder for a secondary purpose to form the seat frame.
